(19) United States
(12) Patent Application Publication
(10) Pub. No.: US 2023/0251662 A1
(43) Pub. Date: Aug. 10, 2023

(54) SYSTEMS AND METHODS FOR ASSISTING HUMAN-DRIVEN VEHICLES OF A MANUFACTURING ENVIRONMENT

(71) Applicant: Ford Global Technologies, LLC, Dearborn, MI (US)

(72) Inventors: Meghna Menon, Rochester Hills, MI (US); Gregory P. Linkowski, Dearborn, MI (US); Yifan Chen, Ann Arbor, MI (US); Geoffrey Horowitz, Birmingham, MI (US); Sarah Garrow, Marshall, MI (US)

(73) Assignee: Ford Global Technologies, LLC, Dearborn, MI (US)

(21) Appl. No.: 17/665,064

(22) Filed: Feb. 4, 2022

(51) Int. Cl. G05D 1/02; G05D 1/00; B65G 1/04; B65G 1/06; B65G 1/137

(52) U.S. Cl. CPC G05D 1/0212; G05D 1/0088; G05D 1/0094; B65G 1/0492; B65G 1/065; B65G 1/1378; G05D 2201/0216

(57) ABSTRACT

A method for controlling a human driven vehicle (HDV) includes identifying HDV indicia of a fiducial marker disposed on the HDV based on localization data obtained from the plurality of localization sensors, determining a pose of the HDV based on the localization data, where the pose of the HDV includes a location and an orientation of the HDV, and defining a bounding region of the HDV based on the HDV indicia and the pose of the HDV. The method includes determining a location-based characteristic of the one or more autonomous devices, where the location-based characteristic includes a location of the one or more autonomous devices, a trajectory of the one or more autonomous devices, or a combination thereof, selectively generating a notification based on the location-based characteristic and the bounding region, and broadcasting the notification to the HDV in response to generating the notification.

### FIELD

The present disclosure relates to systems and methods for assisting human-driven vehicles of a manufacturing environment.

### BACKGROUND

The statements in this section merely provide background information related to the present disclosure and may not constitute prior art.

A manufacturing environment may include various autonomous devices (e.g., an autonomous mobile robot (AMR), an automated guided vehicle (AGV), among others) and human-driven vehicles (HDVs) (e.g., a forklift) that perform or assist with various manufacturing routines. The autonomous devices may autonomously travel along a defined path to arrive at a given destination within the manufacturing environment and subsequently perform an automated task. However, the defined paths of the autonomous devices may coincide with the operation of HDVs, thereby inhibiting the efficiency of the tasks performed by the autonomous devices and the HDVs. These issues with the use of HDVs and autonomous devices in a manufacturing environment, among other issues, are addressed by the present disclosure.

### SUMMARY

This section provides a general summary of the disclosure and is not a comprehensive disclosure of its full scope or all of its features.

The present disclosure provides a method for controlling a human driven vehicle (HDV) of a manufacturing environment including one or more autonomous devices and a plurality of localization sensors, where the one or more autonomous devices include an automated guided vehicle (AGV), an autonomous mobile robot (AMR), or a combination thereof. The method includes identifying HDV indicia of a fiducial marker disposed on the HDV based on localization data obtained from the plurality of localization sensors, determining a pose of the HDV based on the localization data, where the pose of the HDV includes a location and an orientation of the HDV, and defining a bounding region of the HDV based on the HDV indicia and the pose of the HDV. The method includes determining a location-based characteristic of the one or more autonomous devices, where the location-based characteristic includes a location of the one or more autonomous devices, a trajectory of the one or more autonomous devices, or a combination thereof, selectively generating a notification based on the location-based characteristic and the bounding region, and broadcasting the notification to the HDV in response to generating the notification.

The present disclosure provides a method for controlling a human driven vehicle (HDV) of a manufacturing environment including one or more autonomous devices and a plurality of localization sensors, where the one or more autonomous devices include an automated guided vehicle (AGV), an autonomous mobile robot (AMR), or a combination thereof. The method includes identifying HDV indicia of a fiducial marker disposed on the HDV based on localization data obtained from the plurality of localization sensors, determining a pose of the HDV based on the localization data, where the pose of the HDV includes a location and an orientation of the HDV, defining a bounding region of the HDV based on the HDV indicia and the pose of the HDV, and determining a location-based characteristic of the one or more autonomous devices, where the location-based characteristic includes a location of the one or more autonomous devices and a trajectory of the one or more autonomous devices. The method includes determining whether the location-based characteristic satisfies a location condition, where the location condition is satisfied in response to the location-based characteristic indicating the one or more autonomous devices are located within the bounding region, the one or more autonomous devices will be located within the bounding region at a given time, or a combination thereof, generating a notification based on the location-based characteristic and the bounding region in response to the location condition being satisfied, and broadcasting the notification to the HDV in response to generating the notification.

The present disclosure provides a system for controlling a human driven vehicle (HDV) of a manufacturing environment including one or more autonomous devices and a plurality of localization sensors, where the one or more autonomous devices include an automated guided vehicle (AGV), an autonomous mobile robot (AMR), or a combination thereof. The system includes one or more processors and one or more nontransitory computer-readable mediums storing instructions that are executable by the one or more processors. The instructions include identifying HDV indicia of a fiducial marker disposed on the HDV based on localization data obtained from the plurality of localization sensors, determining a pose of the HDV based on the localization data, where the pose of the HDV includes a location and an orientation of the HDV, defining a bounding region of the HDV based on the HDV indicia and the pose of the HDV, and determining a location-based characteristic of the one or more autonomous devices based on the localization data, where the location-based characteristic includes a location of the one or more autonomous devices and a trajectory of the one or more autonomous devices. The instructions include determining whether the location-based characteristic satisfies a location condition, where the location condition is satisfied in response to the location-based characteristic indicating the one or more autonomous devices are located within the bounding region, the one or more autonomous devices will be located within the bounding region at a given time, or a combination thereof. The instructions include generating a notification based on the location-based characteristic and the bounding region in response to the location condition being satisfied and broadcasting the notification to the HDV in response to generating the notification.

In one form, the localization data includes image data obtained from an image sensor from among the plurality of localization sensors, and where the HDV indicia is a two-dimensional barcode. In one form, the method includes determining an image-based distance and an image-based orientation between the image sensor and the fiducial marker based on the image data, determining the location of the HDV based on a comparison of the image-based distance to predefined location coordinates associated with the image sensor, and determining the orientation of the HDV based on a comparison of the image-based orientation to a predefined orientation associated with the image sensor. In one form, the method includes identifying a bounding geometry associated with the HDV indicia, where the bounding geometry includes a size of the bounding region, a shape of the bounding region, or a combination thereof, and where the bounding region is further based on the bounding geometry. In one form, the method includes determining whether the location-based characteristic indicates the one or more autonomous devices are located within the bounding region, where selectively generating the notification further includes generating the notification in response to a determination that the one or more autonomous devices are located within the bounding region. In one form, the notification includes HDV instructions executable by an HDV controller of the HDV, where the HDV instructions include generating a graphical user interface element of the one or more autonomous devices based on the location-based characteristic.

In one form, the method includes determining whether the location-based characteristic indicates the one or more autonomous devices will be located within the bounding region at a given time, where selectively generating the notification further includes generating the notification in response to a determination that the one or more autonomous devices will be located within the bounding region at the given time. In one form, the method includes determining an HDV trajectory of the HDV in response to the determination that the one or more autonomous devices will be located within the bounding region at the given time, where the notification includes HDV instructions executable by an HDV controller of the HDV, and where the HDV instructions include a graphical user interface element associated with the HDV trajectory.

In one form, the notification includes instructions for generating a graphical user interface element of the one or more autonomous devices based on the location-based characteristic. In one form, the method includes determining an HDV trajectory of the HDV in response to a determination that the one or more autonomous devices will be located within the bounding region at the given time, where the notification includes instructions for generating a graphical user interface element associated with the HDV trajectory.

In one form, the instructions include determining an image-based distance and an image-based orientation between the image sensor and the fiducial marker based on the image data, determining the location of the HDV based on a comparison of the image-based distance to predefined location coordinates associated with the image sensor, and determining the orientation of the HDV based on a comparison of the image-based orientation to a predefined orientation associated with the image sensor. In one form, the instructions include identifying a bounding geometry associated with the HDV indicia, where the bounding geometry includes a size of the bounding region, a shape of the bounding region, or a combination thereof, and where the bounding region is further based on the bounding geometry. In one form, the notification includes HDV instructions executable by an HDV controller of the HDV, and the HDV instructions include generating a graphical user interface element of the one or more autonomous devices based on the location-based characteristic. In one form, the instructions include determining an HDV trajectory of the HDV in response to a determination that the one or more autonomous devices will be located within the bounding region at the given time, the notification includes HDV instructions executable by an HDV controller of the HDV, and the HDV instructions include generating a graphical user interface element associated with the HDV trajectory.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a functional block diagram of a manufacturing environment having one or more autonomous devices, a human driven vehicle (HDV), and a central controller in accordance with the teachings of the present disclosure;

FIG. 2 illustrates one or more bounding regions of an HDV in accordance with the teachings of the present disclosure;

FIG. 3 illustrates a notification that indicates one or more autonomous devices are located within a bounding region of an HDV in accordance with the teachings of the present disclosure;

FIG. 4 illustrates a notification that includes an HDV trajectory in accordance with the teachings of the present disclosure; and

FIG. 5 is a flowchart of an example control routine in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides systems and methods for assisting operators of human driven vehicles operating in a manufacturing environment in conjunction with various autonomous devices, such as an automated guided vehicle and an autonomous mobile robot. A central controller is configured to determine the location and orientations of the human driven vehicles. Using the location and orientations, the central controller determines a location-based characteristic of the autonomous devices and define a bounding region of the human driven vehicles. Subsequently, the central controller is configured to selectively generate notifications based on a comparison of the bounding regions and the location-based characteristics. As an example, the notification may cause a display device of the human driven vehicles to generate display elements corresponding to the location and/or trajectory of the autonomous devices when it corresponds to the bounding region of the human driven vehicles. As such, the central controller enables the operators of the human driven vehicle to navigate safely and efficiently within the manufacturing environment.

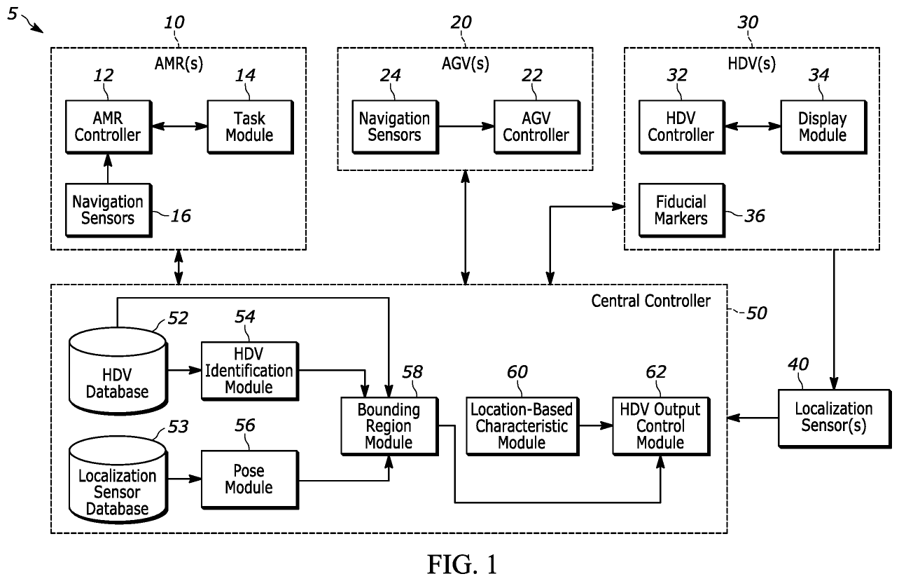

Referring to FIG. 1, a manufacturing environment 5 is provided and generally includes one or more autonomous mobile robots (AMRs) 10-1, 10-2, . . . , 10-n (collectively referred to hereinafter as “AMRs 10”), one or more automated guided vehicles (AGVs) 20-1, 20-2, . . . ,20-n (collectively referred to hereinafter as “AGVs 20”), one or more human-driven vehicles (HDVs) 30-1, 30-2, . . . ,30-n (collectively referred to hereinafter as “HDVs 30”), localization sensors 40, and a central controller 50. It should be readily understood that any one of the modules/controllers of the AMRs 10, the AGVs 20, the HDVs 30, and the central controller 50 can be provided at the same location or distributed at different locations (e.g., via one or more edge computing devices) and communicably coupled accordingly. In one form, the AMRs 10, the AGVs 20, the HDVs 30, the localization sensors 40, and the central controller 50 are communicably coupled using a wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others).

The one or more AMRs 10 and the one or more AGVs 20 may be collectively referred to hereinafter as “the autonomous devices.” To perform the functionality described herein, the autonomous devices and the HDVs 30 may each include one or more processor circuits that are configured to execute machine-readable instructions stored in one or more nontransitory computer-readable mediums, such as a random-access memory (RAM) circuit and/or read-only memory (ROM) circuit. The autonomous devices and the HDVs 30 may also include other components for performing the operations described herein, such as movement drivers and systems, transceivers, routers, and/or input/output interface hardware.

In one form, the AMRs 10 are mobile robots that are partially or fully autonomous and are configured to autonomously move to various locations of the manufacturing environment 5, as instructed by the central controller 50. To autonomously move itself, an AMR controller 12 is configured to control various movement systems of the AMR 10 (e.g., propulsion systems, steering systems, and/or brake systems) via actuators and based on one or more navigation sensors 16 of the AMR 10 (e.g., a global navigation satellite system (GNSS) sensor, an image sensor, a local position sensor, among others). Furthermore, the AMR controller 12 is configured to operate the actuators to control the motion of one or more robotic links (e.g., robotic arms) attached thereto and thereby perform one or more automated tasks defined by a task module 14. The one or more automated tasks may refer to one or more motions the AMR 10 performs to achieve a desired result (e.g., removing an unfinished workpiece from a bin, loading an unfinished or semi-finished workpiece into a fixture, transporting a payload from one location to another, among others).

In one form, the AGVs 20 are mobile robots that are partially or fully autonomous and are configured to autonomously transport manufacturing materials between various locations of the manufacturing environment 5, as instructed by the central controller 50. To autonomously move itself, a AGV controller 22 is configured to control various movement systems of the AGV 20 (e.g., propulsion systems, steering systems, and/or brake systems) based on one or more navigation sensors 24 of the AGV 20 (e.g., a GNSS sensor, an image sensor, a local position sensor, among others). As an example, the AGVs 20 are provided by autonomous pallets that are configured to transport raw, semi-finished, and finished workpieces between various areas of the manufacturing environment 5.

In one form, the HDVs 30 are vehicles that are controlled by a human operator. Example HDVs 30 include, but are not limited to: an automobile, a forklift, a scooter, an excavator, a tractor, among other vehicles that are controllable by a human operator. In one form, the HDVs 30 include a HDV controller 32 that is configured to control various movement systems of the HDV 30 (e.g., propulsion systems, steering systems, and/or brake systems) based on one or more inputs received via the human operator.

In one form, the HDVs 30 include a display module 34 having display components that are configured to display one or more graphical user interface elements based on a notification received from the central controller 50. Example display components include, but are not limited to: a touchscreen display device, an augmented reality (AR) device, a heads-up display (HUD) device, or a virtual reality (VR) device configured to generate a graphical user interface element based on the notification.

In one form, the HDVs 30 include fiducial markers 36 disposed thereon that include HDV indicia that uniquely identifies the respective HDV 30. In one form, the HDV indicia includes images and/or text that uniquely identifies the HDV 30. As an example, the fiducial markers 36 are provided by AprilTags (i.e., 2D barcodes having 4-12 bits) and/or quick response (QR) tags including a 2D barcode that uniquely identifies the HDV 30. In one form, the HDV indicia is provided by radio frequency identification (RFID) information that uniquely identifies the respective HDV 30. As an example, the fiducial markers 36 are provided by RFID tags that are configured to broadcast RF information uniquely identifying the HDV 30 to an RFID module. It should be understood that the fiducial markers 36 may be provided by various other types of uniquely identifying HDV indicia and are not limited to the examples described herein.

In one form, the localization sensors 40 are sensors configured to generate localization data associated with the HDVs 30. As used herein, “localization data” refers to data that is indicative of a location and an orientation of the HDVs 30 (collectively referred to hereinafter as “the pose of the HDVs 30”). In one form, the localization sensors 40 are disposed on various infrastructure elements of the manufacturing environment 5, such as an overhead beam, a tower, a light pole, a building, a sign, a machining device, a stationary storage rack/shelving system, among other infrastructure elements of the manufacturing environment 5.

As an example, the localization sensors 40 are provided by image sensors that obtain image data (as the localization data) of the fiducial markers 36 of the HDVs 30. Example image sensors may include, but are not limited to: a two-dimensional camera, a three-dimensional camera, an infrared sensor, a radar scanner, a laser scanner, among others. As described below in further detail, the central controller 50 is configured to determine the pose of the HDVs 30 based on the image data and using known image-based pose to real pose conversion relations.

As another example, the localization sensors 40 are provided by a plurality of RFID scanners that obtain RFID data (as the localization data) from the fiducial markers 36 of the HDVs 30. As described below in further detail, the central controller 50 is configured to determine the pose of the HDVs 30 by triangulating received signal strength indicator (RSSI) values obtained from the RFID scanners. It should be understood that the localizations sensors 40 can be provided by any sensors that generate data indicative of the pose of the HDVs 30 and is not limited to the examples described herein.

In one form, the central controller 50 includes an HDV database 52, a localization sensor database 53, an HDV identification module 54, a pose module 56, a bounding region module 58, a location-based characteristic module 60, and a HDV output control module 62. In one form, the HDV database 52 stores a plurality of HDV identification entries, where each HDV identification entry associates one of the HDVs 30 and the corresponding HDV indicia of the fiducial marker 36 (e.g., the 2D barcode of the AprilTag or the RFID information). Additionally, each HDV identification entry defines a reference geometry associated with the HDV 30. In one form, the reference geometry identifies a reference size of the fiducial marker 36 (e.g., a reference area, a reference width, a reference length, among others), a reference angle of the fiducial marker 36 (e.g., a reference rotation angle along an axis with respect to a given axial plane), or a combination thereof (i.e., a predefined orientation).

In one form, each HDV identification entry defines a bounding geometry associated with the HDV 30. In one form, the bounding geometry identifies a size of the bounding region (e.g., an area, width, length, among others), a shape of the bounding region, or a combination thereof. As described below in further detail, the bounding region module 58 is configured to generate a bounding region for an HDV 30 based on the bounding geometry defined in the corresponding HDV identification entry.

In one form, the localization sensor database 53 stores a plurality of localization sensor position entries, where each localization position sensor entry identifies position coordinates associated with the localization sensors 40 (e.g., GNSS coordinates).

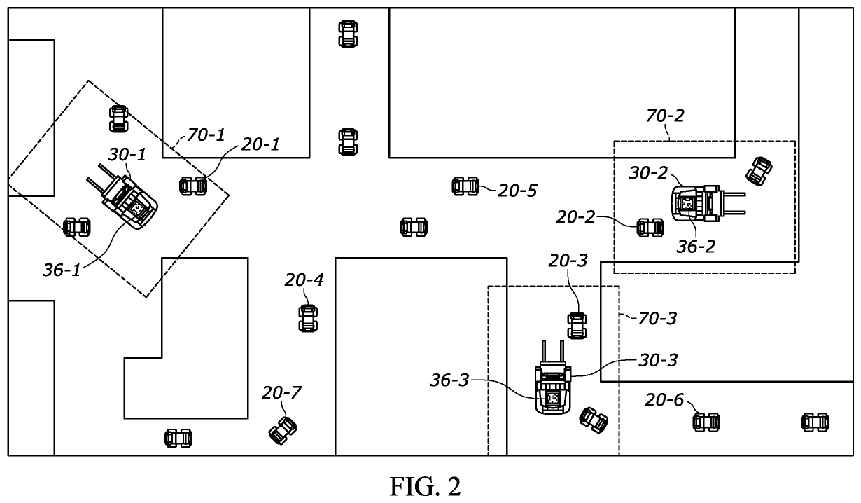

In one form, HDV identification module 54 is configured to identify the HDV indicia of the fiducial markers 36 based on the localization data and a corresponding HDV identification entry of the HDV database 52. As an example and referring to FIGS. 1-2, the fiducial markers 36-1, 36-2, 36-3 of HDVs 30-1, 30-2, 30-3 (as the fiducial markers 36 of the HDVs 30) are provided by AprilTags, and the localization sensors 40 are provided by image sensors. The HDV identification module 54 employs known digital image recognition techniques to process the image data from the localization sensors 40 to decode the HDV indicia. Subsequently, the HDV identification module 54 identifies the corresponding HDVs 30-1, 30-2, 30-3 by locating the corresponding HDV identification entries of the HDV database 52 associated with the decoded HDV indicia.

As another example, when the fiducial markers 36 and the localization sensors 40 are provided by RFID tags provided RFID scanners, respectively, the HDV identification module 54 employs known signal processing routines to process the RFID data and locate the corresponding HDV identification entry of the HDV database 52 associated with the processed RFID data.

In one form, the pose module 56 is configured to determine the pose of the HDV 30 (i.e., the location and the orientation of the HDV) based on the localization data and the localization sensor position entries of the localization sensor database 53. As an example and referring to FIGS. 1-2, the pose module 56 is configured to determine an image-based distance and image-based orientation between the detected fiducial markers 36-1, 36-2, 36-3 and the image sensor (as the one or more localization sensors 40). Specifically, the pose module 56 employs known image-based distance routines to determine the image-based distance employing various characteristics of the image sensors, such as a pixel density, focal length, height, width, and/or geometry of the image sensors. Subsequently, the pose module 56 determines the location of the HDVs 30-1, 30-2, 30-3 based on the image-based distances and the position coordinate associated with the image sensor, as indicated by the corresponding localization sensor position entry of the localization sensor database 53. Similarly, the pose module 56 employs known image-based orientation routines to determine the image-based orientations based on the characteristics of the image sensor and the predefined orientation (i.e., the reference size and shape) associated with the fiducial markers 36-1, 36-2, 36-3, as indicated by the corresponding localization sensor entry.

In one form, the bounding region module 58 is configured to define a bounding region of the HDV 30 based on the detected HDV indicia and the pose of the HDV 30. In one form, the bounding region module 58 identifies the corresponding bounding geometry of the HDV identification entry associated with the detected HDV 30 and defines the bounding region accordingly. As an example and referring to FIGS. 1-2, the bounding region module 58 identifies the bounding geometries associated with the HDVs 30-1, 30-2, 30-3 based on the corresponding HDV identification entries, which each correspond to a rectangular shape and a predefined length and width. Subsequently, the bounding region module 58 generates bounding regions 70-1, 70-2, 70-3 (collectively referred to hereinafter as “bounding regions 70”) based on the identified bounding geometries.

In one form, the location-based characteristic module 60 is configured to determine a location-based characteristic of the one or more autonomous devices, which may include a location of the one or more autonomous, a trajectory of the one or more autonomous, or a combination thereof. In one form, the location-based characteristic module 60 determines the location of the one or more autonomous devices by obtaining the position data from the navigation sensors 16, 24 of the one or more AMRs 10 and the one or more AGVs 20, respectively. In one form, the location-based characteristic module 60 determines the trajectory of the one or more autonomous devices based on the position data from the navigation sensors 16, 24 and/or a path planning routine being performed by the AMR controller 12 and the AGV controller 22, respectively.

In one form, the location-based characteristic module 60 is configured to determine whether the location-based characteristic satisfies a location condition. In one form, the location condition is satisfied in response to the location-based characteristic indicating that the one or more autonomous devices are located within the bounding region 70, the one or more autonomous devices will be located within the bounding region 70 at a given time, or a combination thereof.

As an example and referring to FIGS. 1-2, the location-based characteristic module 60 determines that the location characteristics of AGVs 20-1, 20-2, 20-3 satisfy the location condition, as the AGVs 20-1, 20-2, 20-3 are currently located within the bounding regions 70-1, 70-2, 70-3, respectively. Furthermore, the location-based characteristic module 60 determines that the location characteristics of AGVs 20-4, 20-5, 20-6 satisfy the location condition, as the AGVs 20-4, 20-5, 20-6 has a trajectory indicating that it will be located within the bounding regions 70-1, 70-2, 70-3, respectively. Additionally, the location-based characteristic module 60 determines that the location characteristics of AGV 20-7 does not satisfy the location condition, as it is not located within one of the bounding regions 70 and does not have a trajectory indicating that it will be located within one of the bounding regions 70.

In one form, the HDV output control module 62 is configured to perform on output control routine based on the location-based characteristic and the bounding regions 70. Example output control routines include, but are not limited to: selectively generating and broadcasting a notification based on the location-based characteristic and the bounding region, instructing the HDVs 30 to adjust a corresponding position and/or trajectory, or a combination thereof. In one form, selectively generating the notification includes generating and broadcasting the notification in response to the location-based characteristic satisfying the location condition.

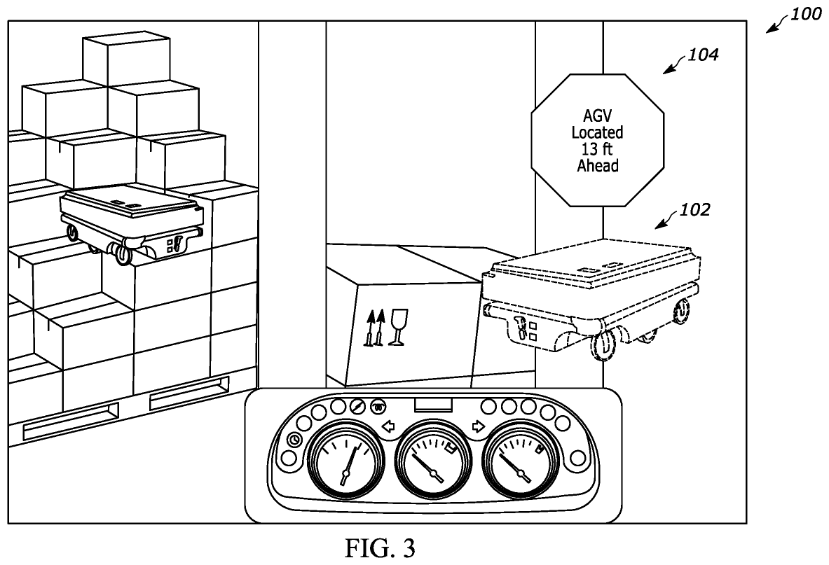

As an example and referring to FIGS. 1-3, the HDV output control module 62 generates and broadcasts a notification to the HDV 30-1 in response to determining that the AGV 20-1 is currently located within the bounding region 70-1, where the notification HDV includes instructions that are executable by the HDV controller 32. Specifically, in response to receiving and executing the HDV instructions, the HDV controller 32 instructs the HUD device (as the display module 34 of the HDV 30-1) to generate an interface 100 having a graphical user interface (GUI) element 102 indicative of the AGV 20-1. Additionally, the HDV controller 32 may instruct the HUD device (as the display module 34 of the HDV 30-1) to generate a GUI element 104 based on the location-based characteristic and/or the pose of the HDV 30-1. Specifically, the GUI element 104 may indicate a distance between the HDV 30-1 and the AGV 20-1.

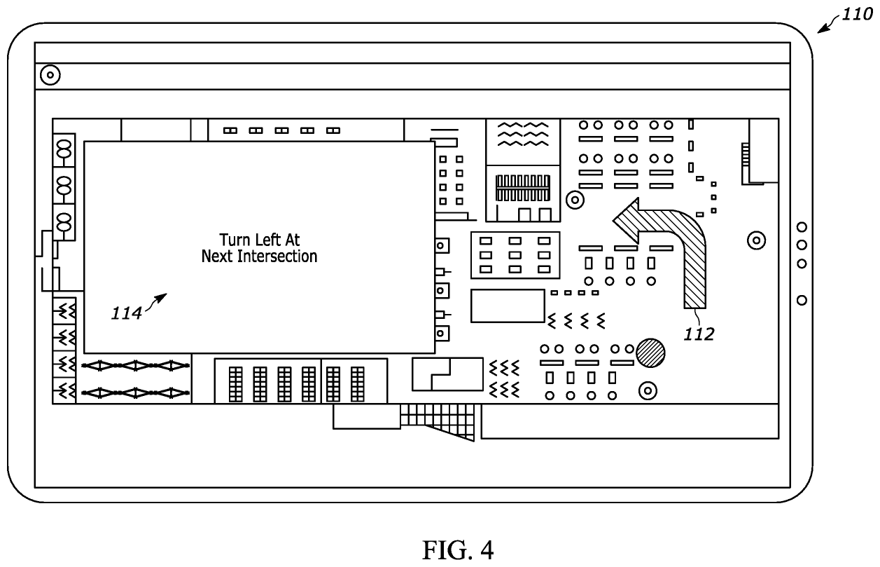

As another example and referring to FIGS. 1-2 and 4, the HDV output control module 62 generates and broadcasts a notification to HDV 30-4 in response to determining that AMR 10-1 will be located within the corresponding bounding region (not shown) at a given time, where the notification HDV includes instructions that are executable by the HDV controller 32. Specifically, in response to receiving and executing the HDV instructions, the HDV controller 32 is configured to determine an HDV trajectory to avoid a trajectory of the AMR 10-1 using known path planning routines and instruct a touchscreen display device (as the display module 34) to display an interface 110 having GUI elements 112, 114 corresponding to the HDV trajectory.

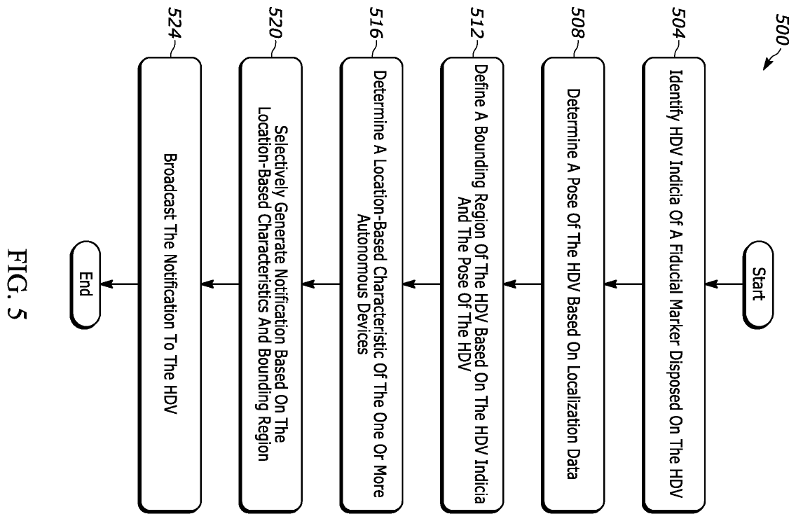

Referring to FIG. 5, a flowchart illustrating a routine 500 for controlling the one or more HDVs 30 is shown. At 504, the central controller 50 identifies HDV indicia of the fiducial marker 36 based on the localization data obtained from the localization sensors 40. At 508, the central controller 50 determines a pose (i.e., a location and an orientation) of the HDV 30 based on the localization data. At 512, the central controller 50 defines a bounding region 70 of the HDV 30 based on the HDV indicia and the pose of the HDV 30. At 516, the central controller 50 determines a location-based characteristic of the one or more autonomous devices. At 520, the central controller 50 selectively generates the notification based on the location-based characteristic and the bounding region. At 524, the central controller 50 broadcasts the notification to the HDV 30 in response to generating the notification.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for controlling a human driven vehicle (HDV) of a manufacturing environment including one or more autonomous devices and a plurality of localization sensors, wherein the one or more autonomous devices include an automated guided vehicle (AGV), an autonomous mobile robot (AMR), or a combination thereof, the method comprising:
identifying HDV indicia of a fiducial marker disposed on the HDV based on localization data obtained from the plurality of localization sensors;
determining a pose of the HDV based on the localization data, wherein the pose of the HDV includes a location and an orientation of the HDV;
defining a bounding region of the HDV based on the HDV indicia and the pose of the HDV; and
determining a location-based characteristic of the one or more autonomous devices, wherein the location-based characteristic includes a location of the one or more autonomous devices, a trajectory of the one or more autonomous devices, or a combination thereof;
selectively generating a notification based on the location-based characteristic and the bounding region; and
broadcasting the notification to the HDV in response to generating the notification.

2. The method of claim 1, wherein the localization data includes image data obtained from an image sensor from among the plurality of localization sensors, and wherein the HDV indicia is a two-dimensional barcode.

3. The method of claim 2 further comprising:
determining an image-based distance and an image-based orientation between the image sensor and the fiducial marker based on the image data;
determining the location of the HDV based on a comparison of the image-based distance to predefined location coordinates associated with the image sensor; and
determining the orientation of the HDV based on a comparison of the image-based orientation to a predefined orientation associated with the image sensor.

4. The method of claim 1 further comprising identifying a bounding geometry associated with the HDV indicia, wherein the bounding geometry includes a size of the bounding region, a shape of the bounding region, or a combination thereof, and wherein the bounding region is further based on the bounding geometry.

5. The method of claim 1 further comprising determining whether the location-based characteristic indicates the one or more autonomous devices are located within the bounding region, wherein selectively generating the notification further comprises generating the notification in response to a determination that the one or more autonomous devices are located within the bounding region.

6. The method of claim 5, wherein the notification includes HDV instructions executable by an HDV controller of the HDV, wherein the HDV instructions include generating a graphical user interface element of the one or more autonomous devices based on the location-based characteristic.

7. The method of claim 1 further comprising determining whether the location-based characteristic indicates the one or more autonomous devices will be located within the bounding region at a given time, wherein selectively generating the notification further comprises generating the notification in response to a determination that the one or more autonomous devices will be located within the bounding region at the given time.

8. The method of claim 7 further comprising determining an HDV trajectory of the HDV in response to the determination that the one or more autonomous devices will be located within the bounding region at the given time, wherein:
the notification includes HDV instructions executable by an HDV controller of the HDV; and
the HDV instructions include a graphical user interface element associated with the HDV trajectory.

9. A system for controlling a human driven vehicle (HDV) of a manufacturing environment including one or more autonomous devices and a plurality of localization sensors, wherein the one or more autonomous devices include an automated guided vehicle (AGV), an autonomous mobile robot (AMR), or a combination thereof, the system comprising:
one or more processors and one or more nontransitory computer-readable mediums storing instructions that are executable by the one or more processors, wherein the instructions comprise:
identifying HDV indicia of a fiducial marker disposed on the HDV based on localization data obtained from the plurality of localization sensors;
determining a pose of the HDV based on the localization data, wherein the pose of the HDV includes a location and an orientation of the HDV;
defining a bounding region of the HDV based on the HDV indicia and the pose of the HDV;
determining a location-based characteristic of the one or more autonomous devices, wherein the location-based characteristic includes a location of the one or more autonomous devices and a trajectory of the one or more autonomous devices;
determining whether the location-based characteristic satisfies a location condition, wherein the location condition is satisfied in response to the location-based characteristic indicating the one or more autonomous devices are located within the bounding region, the one or more autonomous devices will be located within the bounding region at a given time, or a combination thereof;
generating a notification based on the location-based characteristic and the bounding region in response to the location condition being satisfied; and
broadcasting the notification to the HDV in response to generating the notification.

10. The system of claim 9, wherein the localization data includes image data obtained from an image sensor from among the plurality of localization sensors, and wherein the HDV indicia is a two-dimensional barcode.

11. The system of claim 10, wherein the instructions further comprise:
determining an image-based distance and an image-based orientation between the image sensor and the fiducial marker based on the image data;
determining the location of the HDV based on a comparison of the image-based distance to predefined location coordinates associated with the image sensor; and
determining the orientation of the HDV based on a comparison of the image-based orientation to a predefined orientation associated with the image sensor.

12. The system of claim 9, wherein the instructions further comprise identifying a bounding geometry associated with the HDV indicia, wherein the bounding geometry includes a size of the bounding region, a shape of the bounding region, or a combination thereof, and wherein the bounding region is further based on the bounding geometry.

13. The system of claim 9, wherein:
the notification includes HDV instructions executable by an HDV controller of the HDV; and
the HDV instructions include generating a graphical user interface element of the one or more autonomous devices based on the location-based characteristic.

14. The system of claim 9, wherein:
the instructions further comprise determining an HDV trajectory of the HDV in response to a determination that the one or more autonomous devices will be located within the bounding region at the given time;
the notification includes HDV instructions executable by an HDV controller of the HDV; and
the HDV instructions include generating a graphical user interface element associated with the HDV trajectory.

15. A method for controlling a human driven vehicle (HDV) of a manufacturing environment including one or more autonomous devices and a plurality of localization sensors, wherein the one or more autonomous devices include an automated guided vehicle (AGV), an autonomous mobile robot (AMR), or a combination thereof, the method comprising:
identifying HDV indicia of a fiducial marker disposed on the HDV based on localization data obtained from the plurality of localization sensors;
determining a pose of the HDV based on the localization data, wherein the pose of the HDV includes a location and an orientation of the HDV;
defining a bounding region of the HDV based on the HDV indicia and the pose of the HDV;
determining a location-based characteristic of the one or more autonomous devices, wherein the location-based characteristic includes a location of the one or more autonomous devices and a trajectory of the one or more autonomous devices;
determining whether the location-based characteristic satisfies a location condition, wherein the location condition is satisfied in response to the location-based characteristic indicating the one or more autonomous devices are located within the bounding region, the one or more autonomous devices will be located within the bounding region at a given time, or a combination thereof;
generating a notification based on the location-based characteristic and the bounding region in response to the location condition being satisfied; and
broadcasting the notification to the HDV in response to generating the notification.

16. The method of claim 15, wherein the localization data includes image data obtained from an image sensor from among the plurality of localization sensors, and wherein the HDV indicia is a two-dimensional barcode.

17. The method of claim 16 further comprising:
determining an image-based distance and an image-based orientation between the image sensor and the fiducial marker based on the image data;
determining the location of the HDV based on a comparison of the image-based distance to predefined location coordinates associated with the image sensor; and
determining the orientation of the HDV based on a comparison of the image-based orientation to a predefined orientation associated with the image sensor.

18. The method of claim 15 further comprising identifying a bounding geometry associated with the HDV indicia, wherein the bounding geometry includes a size of the bounding region, a shape of the bounding region, or a combination thereof, and wherein the bounding region is further based on the bounding geometry.

19. The method of claim 15, wherein the notification includes instructions for generating a graphical user interface element of the one or more autonomous devices based on the location-based characteristic.

20. The method of claim 15 further comprising determining an HDV trajectory of the HDV in response to a determination that the one or more autonomous devices will be located within the bounding region at the given time, wherein the notification includes instructions for generating a graphical user interface element associated with the HDV trajectory.
